(19) United States
(12) Patent Application Publication
(10) Pub. No.: US 2022/0036172 A1
(43) Pub. Date: Feb. 3, 2022

(54) OLFACTORY PREDICTIONS USING NEURAL NETWORKS

(71) Applicant: DeepMind Technologies Limited, London (GB)

(72) Inventors: Brendan Shillingford, London (GB); Jakob Nicolaus Foerster, San Francisco, CA (US)

(21) Appl. No.: 16/942,625

(22) Filed: Jul. 29, 2020

(51) Int. Cl. G06N 3/08; G06N 3/04; G06K 9/00; G06K 9/62

(52) U.S. Cl. CPC G06N 3/08; G06K 9/6256; G06K 9/00664; G06N 3/0454

(57) ABSTRACT

Methods, systems, and apparatus, including computer programs encoded on computer storage media, for generating olfactory predictions using neural networks. One of the methods includes receiving scene data characterizing a scene in an environment; processing the scene data using a representation neural network to generate a representation of the scene; and processing the representation of the scene using a prediction neural network to generate as output an olfactory prediction that characterizes a predicted smell of the scene at a particular observer location.

### BACKGROUND

This specification relates to predicting olfactory stimuli using neural networks. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that receives as input scene data characterizing a scene in an environment and generates as output an olfactory prediction that characterizes a predicted smell or scent of the scene at a particular observer location. For example, when the input scene data is an image or a video of the environment, the particular observer location can be the location of the camera that captured the image or video. Optionally, the olfactory prediction or data derived from the olfactory prediction can then be provided to a hardware device that is configured to generate the predicted smell.

Particular embodiments of the subject matter described in this specification can be implemented so as to realize one or more of the following advantages.

Olfactory stimuli are known to be essential components of a holistic perception of reality, but are currently vastly underrepresented in the digital and online experiences that are available to users. However, even if hardware for generating smells is available, existing digital media is not annotated with smell meta-data and manually annotating a significant amount of digital media with smell data is impractical. Using the described techniques, olfactory stimuli can effectively be predicted without requiring annotating a significant amount of digital media with smell data. By using the predicted olfactory stimuli, the user experience of users interacting with the digital media can be enhanced. Moreover, the olfactory prediction neural network used to generate the predictions can leverage un-labeled data or data that has been labeled with other types of labels for which large data sets are readily available, e.g., object detection or image segmentation labels, to learn representations of scenes and allow the model to generate olfactory predictions that are accurate with only a limited amount of labeled training data.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example olfactory prediction system.

FIG. 2 is a flow diagram of an example process for generating an olfactory prediction.

FIG. 3 is a flow diagram of another example process for generating an olfactory prediction.

Like reference numbers and designations in the various drawings indicate like elements.

### DETAILED DESCRIPTION

This specification describes a system implemented as computer programs on one or more computers in one or more locations that generates, from scene data characterizing a scene in an environment, an olfactory prediction that characterizes a predicted smell or scent that would be sensed at a particular observer location in the environment.

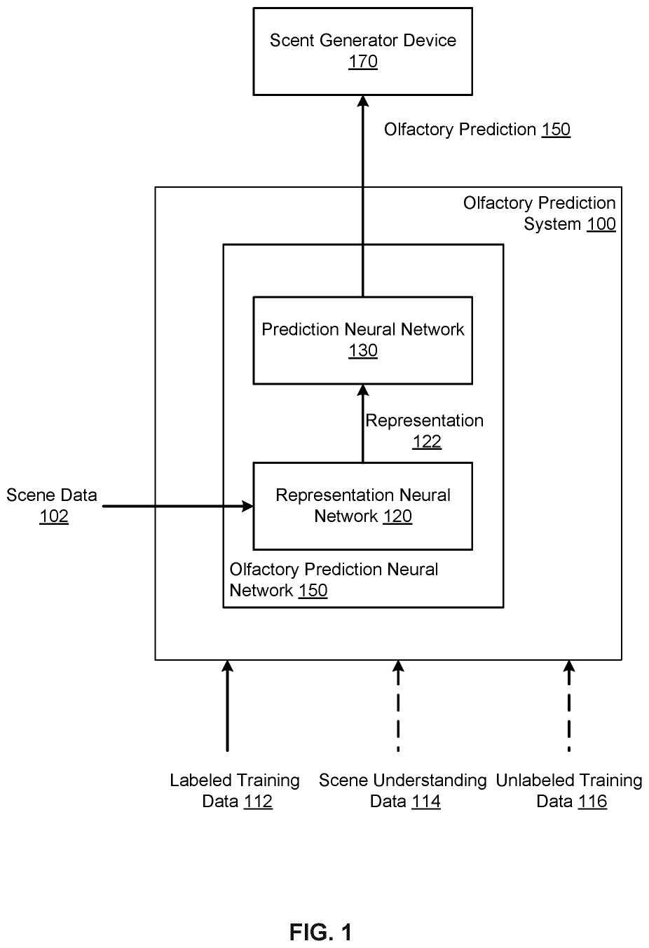

FIG. 1 shows an example olfactory prediction system 100. The olfactory prediction system 100 is an example of a system implemented as computer programs on one or more computers in one or more locations, in which the systems, components, and techniques described below can be implemented.

The olfactory prediction system 100 is a system that receives as input scene data 102 characterizing a scene in an environment.

In some implementations, the scene data 102 is visual data characterizing the scene in the environment.

For example the scene data can be an image of a real-world environment captured by a camera, e.g., an RGB image or an RGB-D image. As another example, the scene can be a synthetic scene in a virtual environment and the scene data can be an image of the environment generated by a computer graphics engine or other computer simulation engine from the perspective of a camera located at a particular location.

As another example, the scene data can be a video, i.e., a sequence of video frames, captured by a camera or generated by a computer simulation engine.

In particular, while this specification describes the scene data 102 as being visual data, more generally, the described techniques can be applied to any data that characterizes a scene in an environment. Other examples of scene data include text data, i.e., a written description of a scene in an environment in a particular natural language, and audio data, e.g., speech or music that describes a scene in an environment.

The system 100 processes the scene data 102 using an olfactory prediction neural network 150 to generate an olfactory prediction 152. That is, the olfactory prediction neural network 150 is a neural network having parameters that is configured to receive the scene data 102 as input and to process the scene data 102 in accordance with the parameters to generate the olfactory prediction 152.

The olfactory prediction 152 is data characterizing a scent that would be sensed at a particular observer location in the environment. For example, the particular observer location can be the location of the camera that captured the video data or that is being modeled by the computer simulation engine. Thus, in this example, the olfactory prediction 152 predicts the scent that would be sensed by an operator of the camera (or other person located at the camera location) at the time that the scene data is captured.

Specifically, the olfactory prediction 152 can be a prediction of a scent at the particular observer location along a number of olfactory dimensions.

Each olfactory dimension can be represented by a basis vector and can correspond to a particular known scent, e.g., to the scent produced by particular organic compound or to the scent produced by a known combination of multiple particular organic compounds. The basis vector for a given dimension can represent the contribution to the overall scent at the particular observation location from the corresponding scent. As a particular example, each basis vector can correspond to a different known scent in library of known scents that is available to the system 100.

The olfactory prediction 152 can therefore include a respective score for each of the olfactory dimensions that represents an intensity of the corresponding olfactory dimension at the particular observer location. In other words, the output of the neural network 150 is a set of scores, with each score corresponding to one of the olfactory dimensions. The score for a given olfactory dimension represents a weight that should be assigned to the basis vector for the olfactory dimension in computing the overall scent at the particular location. Optionally, the system 100 can then compute a weighted sum of the basis vectors, each weighted by the corresponding score in the olfactory prediction 152, to generate a final overall predicted scent at the particular observer location.

Once the olfactory prediction 152 has been generated, the system 100 can store data identifying the olfactory prediction 152 in association with the scene data 102, e.g., for later use by another system in generating olfactory experiences for users in association with the scene data 102.

Alternatively or in addition, the system 100 can provide the olfactory prediction 152 or data derived from the olfactory prediction 152 to a scent generator device 170 that can generate the scent that is characterized by the olfactory prediction 152 so that the scent can be sensed by a user.

For example, the system 100 can be coupled to the scent generator device 170 or can communicate with the scent generator device 170 over a data communication network, e.g., the Internet, to provide the olfactory prediction data to the scent generator device.

The scent generator device 170 can be any of a variety of digital scent technology devices that generate scents to be sensed by users from an input scent representations. Like the olfactory prediction 152, the input scent representation of the desired scent is generally a weighted combination of multiple different known scents or odors. Some examples of scent generator devices include those described in Kim, Hyunsu; et al. (14 Jun. 2011). “An X-Y Addressable Matrix Odor-Releasing System Using an On-Off Switchable Device”. Angewandte Chemie. 50 (30): 6771-6775 and Hariri, Surina (16 Nov. 2016). “Electrical stimulation of olfactory receptors for digitizing smell”. Proceedings of the 2016 workshop on Multimodal Virtual and Augmented Reality—MVAR '16. dl.acm.org/. Mvar '16. pp. 4:1-4:4. However, the system 100 can be configured to provide data to any scent generator device that receives as input (or that assigns as part of generating a final scent) weights for each of a plurality of known scents.

Because different scent generator devices 170 may have different scent representations, i.e., may represent overall scents as different combinations of known scents, the system 100 may need to perform post-processing of the olfactory prediction 152 to generate the input to any given scent generator device 170. In particular, the system may need to perform a conversion from the representation in the olfactory prediction 152 to the representation required by the scent generator device 170 by performing a basis conversion. As a particular example, if the olfactory prediction 152 has three basis vectors corresponding to three olfactory dimensions A, B, and C, but a given scent generator device 170 requires a representation that has three scent components, (0.8*A+B), B, and 0.5*C, the system can convert the weights for the dimensions A, B, and C into weights for (0.8*A+B), B, and 0.5*C to generate the input to the scent generator device 170. If, for example, the scent generator device 170 requires a weight for a dimension D that is not reflected in the olfactory prediction 152, the system 100 can set the weight to dimension D to zero in the input to the scent generator device 170.

The olfactory prediction neural network 150 includes a scene representation neural network 120 and a prediction neural network 130.

The scene representation neural network 120 receives the scene data 102 and processes the scene data 102 to generate a representation 122 of the scene. Generally, the representation 122 of the scene is data representing the scene in a form that can be used to make an olfactory prediction 152. Different types of representations 122 that can be generated by the scene representation neural network 120 and different possible architectures for the scene representation neural network 120 are described below.

The prediction neural network 130 then receives the representation 122 of the scene generated by the scene representation neural network 120 and processes the representation 122 to generate the olfactory prediction 152. The processing performed by the prediction neural network 130 to generate the olfactory prediction depends on the form of the representation 122 and will be described in more detail below.

To allow the olfactory prediction neural network 150 to accurately predict the scent of a scene, i.e., to generate accurate olfactory predictions 152, the system 100 trains the neural network 150, i.e., trains the neural network 130 and in some cases the neural network 120, to determine trained values of the parameters of the neural network 150, i.e., to determine trained values of the parameters of the neural networks 120 and 130.

More specifically, the system 100 trains the neural network 150 on labeled training data 112 and optionally also on scene understanding training data 114 or unlabeled scene data 116.

The labeled training data 112 includes multiple labeled training examples, with each labeled training example including (i) scene data and (ii) a ground truth olfactory prediction 152 for the scene data, i.e., a known output that should be generated by the neural network 150 by processing the scene data in the training example.

The scene understanding training data 114, on the other hand, includes multiple labeled training examples, with each labeled training example including (i) scene data and (ii) a ground truth scene understanding output for the scene data, i.e., a known output that should be generated for a scene understanding task, e.g., object detection or image segmentation, by processing the scene data in the training example.

The unlabeled scene data 116 is scene data for which no label identifying a ground truth output is available to the system 100 or, more generally, scene data for which no label is used by the system 100 during training. Because no task-specific labels are required, unlabeled data is generally more readily available for use in model training than task-specific labeled data.

In some implementations, the system 100 uses only the labeled training data 112 and trains the scene representation neural network 120 and the prediction neural network 130 jointly (and end-to-end) on the labeled training data 112.

In these implementations, the representation neural network 120 is a neural network, e.g., a convolutional neural network, that is configured to map the scene data 102 to a feature map that has a spatial dimension that is the same as or less than the scene data 102 but that has a depth dimension that is larger than the scene data 102. That is, the representation 122 can be a feature map that includes a respective feature vector for each of a set of spatial locations in the scene data 102. The prediction neural network 130 is a neural network, e.g., also a convolutional neural network, that is configured to process the feature map to directly generate the olfactory prediction 150. As a particular example, the representation neural network 120 can have the same architecture as the “backbone” neural network, i.e., the initial set of neural network layers, of a scene understanding model while the prediction neural network 130 can include one or more blocks of convolutional layers followed by a set of fully-connected layers that generate logits for each of the olfactory dimensions and followed by a softmax layer that maps the logits to probabilities (or weights) for the olfactory dimensions. Some examples of scene understanding models that have backbone neural networks are identified detail below.

During the joint training, the system 100 can train the representation neural network 120 and the prediction neural network 130 on the labeled data 112 using an appropriate machine learning technique, e.g., a gradient-descent based technique, to minimize an appropriate loss function that measures errors between ground-truth olfactory outputs and olfactory predictions generated by the prediction neural network 130. For example, the loss function can be a regression loss function, e.g., an L2 loss or squared distance loss, between a vector representing the overall scent at the location according to the olfactory prediction and a vector representing the overall scent at the location according to the ground-truth olfactory output. As another example, the loss function can be a classification loss, e.g., a cross-entropy loss, between the scores for the olfactory dimensions in the olfactory prediction and the scores for the olfactory dimensions in the ground-truth olfactory output.

Labeled training data 112 may be difficult to obtain, however. For example, there may be a limited number of data sets that include image or video data annotated with smell or scent data. Thus, the ground truth labels may need to be manually generated, e.g., by users of the system. To allow the neural network 150 to generate accurate olfactory predictions even if the amount of labeled training data available is limited, the system 100 can make use of the scene understanding training data 114 or the unlabeled scene data 116.

In particular, in some implementations, the system can employ a semi-supervised learning technique that makes use of the unlabeled scene data 116 in addition to the labeled data 112 to train the neural network 150.

In these examples, the neural network 150 can have a similar architecture to the one described above when the neural networks 120 and 130 are trained end-to-end on labeled data 112. By making use of semi-supervised learning, the system 100 can leverage the unlabeled training data 116 to improve the quality of the olfactory predictions generated by the neural network 150 even when limited labeled data 112 is available.

Generally, when training using semi-supervised learning, the system 100 leverages the unlabeled training data 116 to allow the representation neural network 120 to generate more informative representations and to prevent the prediction neural network 130 from overfitting to the limited amount of labeled data 112 while encouraging the neural network 120 and the neural network 130 to generalize to unseen data.

More specifically, the system 100 can use any of a variety of semi-supervised learning techniques to train the neural network 150. Examples of semi-supervised learning techniques include those described in Sohn, et al, FixMatch: Simplifying Semi-Supervised Learning with Consistency and Confidence, arXiv:2001.07685 and Xie, et al, Unsupervised Data Augmentation for Consistency Training, arXiv:1904.12848.

In some cases, the unlabeled scene data 116 can be scene data from a target domain, i.e., drawn from the same domain as the scene data which the neural network 150 will operate on after training, while all of the labeled data 112 or a very large proportion of the labeled data 112 is scene data from a source domain that is different from the target domain. As a particular example, after training, the system 100 may use the neural network 150 to make predictions for scene data captured by a physical camera and characterizing real-world scenes (target domain) but may only have available synthetic data generated by a computer program, i.e., a computer program that attempts to model a real-world environment (source domain). In these cases, the system can use a domain adaptation technique to train the neural network 150 on both the unlabeled scene data 116 and the labeled scene data 112 in order to allow the neural network 150 to be trained to accurately generate olfactory predictions for scene data from the target domain even when little or no target domain labeled data is available. Examples of domain adaptation that can be employed include those described in Bousmalis, et al, Unsupervised Pixel-Level Domain Adaptation with Generative Adversarial Networks, arXiv:1612.05424 and Bousmalis, et al, Domain Separation Networks, arXiv:1608.06019.

As another example, in some implementations, the scene representation neural network 120 leverages at least a portion of a scene understanding model that is configured to perform a scene understanding task, e.g., object detection or image segmentation, to configure the scene representation neural network 120.

The system can use any scene understanding model that is configured to process the type of scene data that is received as input by the neural network 150. For example, the system can use an object detection model similar to those described in Tan, et al, EfficientDet: Scalable and Efficient Object Detection, arXiv:1911.09070 or an image segmentation model similar to those described in Chen, et al, Searching for Efficient Multi-Scale Architectures for Dense Image Prediction, arXiv: 1809.0418.

In other words, the system 100 trains the scene understanding model on the scene understanding training data 114 or obtains data specifying a trained scene understanding model, i.e., that has already been trained on the scene understanding training data 114 and uses at least some of the layers of the trained scene understanding model as the scene representation neural network 120.

In some of these implementations, the scene representation neural network 120 can be the entire scene understanding model that has already been trained to perform the scene understanding task and the representation 122 can be the output for the scene understanding task. That is, for a given image in the scene data, the output can identify the portions of the image that depict objects and, optionally, a predicted distance of each identified object from the particular observer location. When the task is object detection, the portions can be bounding boxes in the input image that correspond to the portion of the image that depicts the object. When the task is image segmentation, the portions can be sets of individual pixels in the image that depict an object, i.e., segments of the image that depict objects.

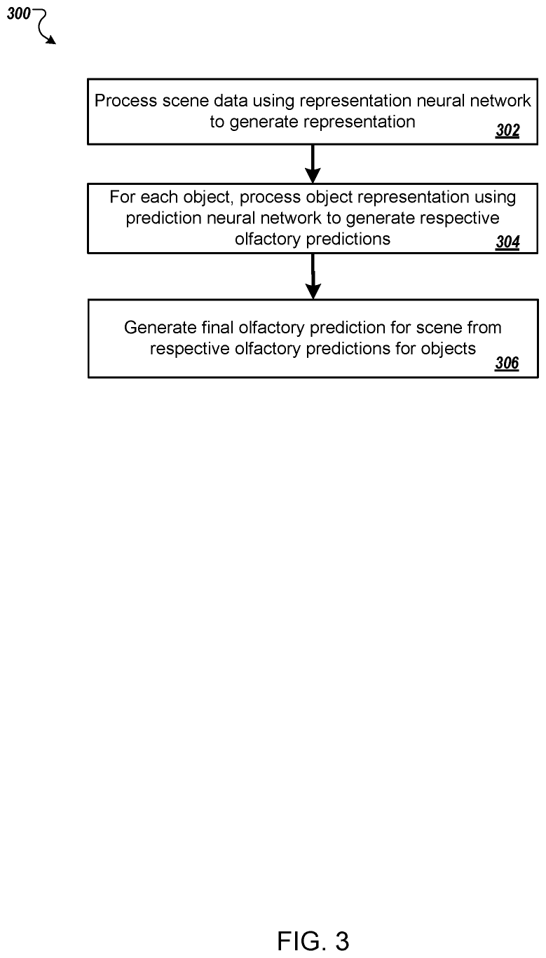

In other words, in these implementations, the representation 130 includes a respective object representation for each object that is identified in the scene data and that is generated based on the portion of the scene data that depicts the object. Examples of object representations are described below with reference to FIG. 3.

In these implementations, the prediction neural network 130 is a neural network, e.g., a convolutional neural network, that is configured to (i) process, for each identified object, the object representation for the object to generate an object olfactory prediction that represents a contribution of the object to the overall scent of the scene at the particular observer location and (ii) combine the object olfactory predictions to generate the olfactory prediction 152.

This example is described in more detail below with reference to FIG. 3.

In some other implementations, the scene representation neural network 120 can be a portion of a scene understanding model that has already been trained to perform the scene understanding task and the representation 122 is an intermediate representation that would be generated by the scene understanding model during processing of the scene data for the scene understanding task. That is, the scene representation neural network 120 includes only a proper subset of the layers of the scene understanding model, i.e., starting from the input layer(s) of the scene understanding model up until one of the hidden layers of the scene understanding model, and the representation 122 is the output of one or more of the hidden layers that are in the proper subset. In other words, the representation 122 is a feature map that is generated from the outputs of one or more of the hidden layers of a scene understanding model.

In this example, the prediction neural network 130 is a neural network, e.g., a convolutional neural network, that is configured to process the representation 122, i.e., the intermediate representation of the scene understanding model, to generate the olfactory prediction 152. In other words, in this example, because the representation 122 includes only a single representation of the entire scene, the prediction neural network 130 directly generates the olfactory prediction 152 for the entire scene from the representation 122.

In implementations in which the system 100 uses the scene understanding training data 114, after the scene understanding model has been trained on the scene understanding training data 115, the system 100 trains the prediction neural network 130 on the labeled data 112 to determine trained values of the parameters of the prediction neural network 130 while holding the values of the parameters of the scene representation neural network 120, i.e., the parameters that were trained on the scene understanding training data 114, fixed.

Once the system 100 has trained the neural network 150 using one of the above techniques (or a different appropriate machine learning training technique), the system 100 can deploy the neural network 150 for use in generating new olfactory predictions 150 for new scene data 102, i.e., for scene data that is not present in the labeled training data 112.

In some implementations, the scene data 102 can include additional data in addition to visual data. For example, the data 102 can include additional data of other modalities captured by other sensors in the environment, i.e., in addition to the camera that captured the visual data. Examples of additional data can include speech data captured by microphones or touch signals captured by haptic sensors. In these implementations, the scene representation neural network 120 can have a separate subnetwork that is configured to process each modality of data and then combine, e.g., by concatenating, averaging, or processing the concatenated outputs through one or more additional layers, the outputs of these separate subnetworks to generate the representation 122 of the scene.

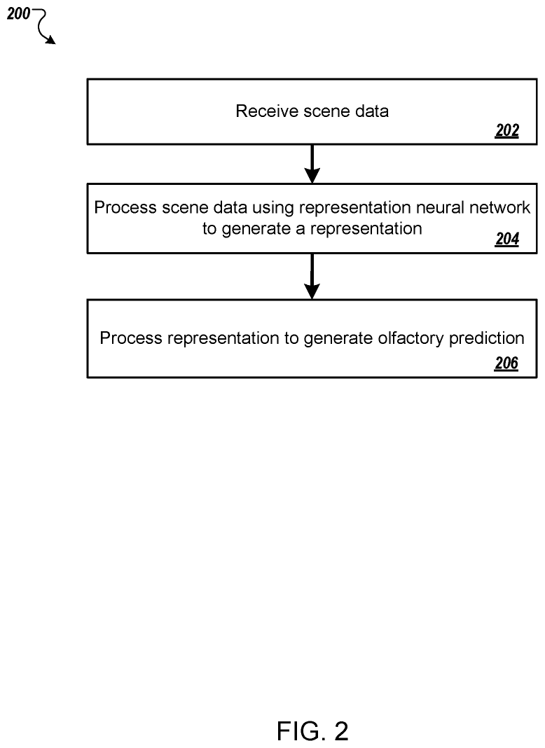

FIG. 2 is a flow diagram of an example process 200 for generating an olfactory prediction. For convenience, the process 200 will be described as being performed by a system of one or more computers located in one or more locations. For example, a olfactory prediction system, e.g., the olfactory prediction system 100 of FIG. 1, appropriately programmed, can perform the process 200.

The system receives scene data characterizing a scene in an environment (step 202).

The system processes the scene data using a representation neural network to generate a representation of the scene (step 204). As described above, in some implementations, the representation is a single tensor, e.g., a vector, matrix, or feature map, that represents information that is relevant to the overall scent of the scene as has been extracted by the representation neural network. In some other implementations, the representation includes respective object representations for each object that is identified in the scene.

The system processes the representation using a prediction neural network to generate an olfactory prediction that characterizes a smell or scent of the environment at a particular observer location in the environment (step 206). When the representation is a single tensor, the prediction neural network directly generates the olfactory prediction for the scene by processing the representation. When the representation includes multiple object representations, the prediction neural network processes, for each identified object, the object representation for the object to generate an object olfactory prediction that represents a contribution of the object to the overall scent of the scene at the particular observer location and combine the object olfactory predictions to generate the olfactory prediction. This processing is described in more detail below with reference to FIG. 3.

In some cases, as described above, the scene data will be video data that includes multiple video frames each captured at different time points. In these cases, the final olfactory prediction for a given time point can depend not only on the video frame captured at the time point but also on the olfactory predictions for time points that precede the given time point in the video data. As a particular example, the system can generate the final olfactory prediction for a given time point by applying a time decay function to (i) the olfactory prediction generated by processing the video frame at the current time point and (ii) the olfactory predictions generated by processing the video frames at one or more preceding time points, e.g., all of the preceding time points or each preceding time point that is within a fixed time window of the given time point.

FIG. 3 is a flow diagram of another example process 300 for generating an olfactory prediction. For convenience, the process 300 will be described as being performed by a system of one or more computers located in one or more locations. For example, an olfactory prediction system, e.g., the olfactory prediction system 100 of FIG. 1, appropriately programmed, can perform the process 300.

In particular, the system performs the process 300 when the representation neural network is a scene understanding model that generates scene understanding outputs that identify portions of the scene data that depict objects.

The system processes the scene data using the representation neural network to generate a representation of the scene (step 302).

In the example of FIG. 3, the representation of the scene includes multiple object representations, one for each object identified in the scene.

In particular, the representation neural network generates a scene understanding output that identifies the portions of the scene data that depict objects.

The system then generates the object representations based on the identified portions. The object representation for any given object will generally include (i) the portion of the scene data that has been identified as depicting the object, (ii) features generated by the representation neural network for the portion of the scene data that has been identified as depicting the object, i.e., a portion of the output of one or more intermediate layers of the representation neural network that corresponds to the identified portion, or (iii) both. The object representation can also optionally include additional information, e.g., a predicted or known distance of the object from particular observer location. That is, in some cases, the scene understanding output can include a predicted depth for each identified object while in other cases the system can receive the depth as input, e.g., when the scene data is an RGB-D image or when the scene data is synthetic data that is generated using a computer program that has access to the depth of each location in the scene data.

For each object identified in the scene representation, the system processes the object representation characterizing the object using the prediction neural network to generate a respective object olfactory prediction for the object that represents a contribution of the object to the overall scent of the scene at the particular observer location (step 304).

Like the final olfactory prediction, each olfactory prediction for an identified object will include a respective score for each of the olfactory dimensions.

The system generates a final olfactory prediction for the scene from the respective olfactory predictions generated for the identified objects (step 306).

In some implementations, the system combines the respective olfactory predictions using the predicted or actual distances. For example, the system can sum over the olfactory predictions for all objects, weighted inversely by their distance from the predicted observer location to generate the final olfactory prediction for the scene. That is, the system computes a weighted sum of the olfactory predictions, with each olfactory prediction being weighted by a weight that is inversely proportional to the distance of the corresponding object from the predicted observer location. In some other implementations, the prediction neural network also includes a learned aggregator model, e.g., composed of one or more fully-connected neural network layers or one or more linear layers, that processes the respective olfactory predictions for all of the objects to generate the final olfactory prediction for the scene.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving scene data characterizing a scene in an environment;
processing the scene data using a representation neural network to generate a representation of the scene; and
processing the representation of the scene using a prediction neural network to generate as output an olfactory prediction that characterizes a predicted smell of the scene at a particular observer location.

2. The method of claim 1, wherein the input scene data is an image or a video of the environment, and wherein the particular observer location is a location of the camera that captured the image or video in the environment.

3. The method of claim 1, further comprising:
providing the olfactory prediction to a hardware device that is configured to generate the predicted smell.

4. The method of claim 1, wherein the olfactory prediction is a prediction of a scent at the particular observer location along a plurality of olfactory dimensions.

5. The method of claim 4, wherein each olfactory dimension is represented by a basis vector and corresponds to a different known smell.

6. The method of claim 4, wherein the olfactory prediction includes a respective score for each of the olfactory dimensions.

7. The method of claim 1, wherein the representation of the scene identifies a plurality of portions of the scene data that depict objects, and wherein processing the representation of the scene using a prediction neural network to generate as output an olfactory prediction that characterizes a predicted smell of the scene at a particular observer location comprises:
for each identified object, processing an object representation characterizing the object using the prediction neural network to generate an object olfactory prediction that characterizes a contribution of the corresponding object to the smell of the scene at the particular observer location; and
determining the olfactory prediction from the object olfactory predictions.

8. The method of claim 7, wherein determining the olfactory prediction comprises:
obtaining, for each identified object, a distance of the identified object from the particular observer location; and
summing over the olfactory predictions with each olfactory prediction weighted inversely by the distance for the corresponding object.

9. A system comprising one or more computers and one or more storage devices storing instructions that when executed by the one or more computers cause the one or more computers to perform operations comprising:
receiving scene data characterizing a scene in an environment;
processing the scene data using a representation neural network to generate a representation of the scene; and
processing the representation of the scene using a prediction neural network to generate as output an olfactory prediction that characterizes a predicted smell of the scene at a particular observer location.

10. The system of claim 9, wherein the input scene data is an image or a video of the environment, and wherein the particular observer location is a location of the camera that captured the image or video in the environment.

11. The system of claim 9, the operations further comprising:
providing the olfactory prediction to a hardware device that is configured to generate the predicted smell.

12. The system of claim 9, wherein the olfactory prediction is a prediction of a scent at the particular observer location along a plurality of olfactory dimensions.

13. The system of claim 12, wherein each olfactory dimension is represented by a basis vector and corresponds to a different known smell.

14. The system of claim 12, wherein the olfactory prediction includes a respective score for each of the olfactory dimensions.

15. The system of claim 9, wherein the representation of the scene identifies a plurality of portions of the scene data that depict objects, and wherein processing the representation of the scene using a prediction neural network to generate as output an olfactory prediction that characterizes a predicted smell of the scene at a particular observer location comprises:
for each identified object, processing an object representation characterizing the object using the prediction neural network to generate an object olfactory prediction that characterizes a contribution of the corresponding object to the smell of the scene at the particular observer location; and
determining the olfactory prediction from the object olfactory predictions.

16. The system of claim 15, wherein determining the olfactory prediction comprises:
obtaining, for each identified object, a distance of the identified object from the particular observer location; and
summing over the olfactory predictions with each olfactory prediction weighted inversely by the distance for the corresponding object.

17. One or more non-transitory computer-readable storage media storing instructions that when executed by one or more computers cause the one or more computers to perform operations comprising:
receiving scene data characterizing a scene in an environment;
processing the scene data using a representation neural network to generate a representation of the scene; and
processing the representation of the scene using a prediction neural network to generate as output an olfactory prediction that characterizes a predicted smell of the scene at a particular observer location.

18. The computer-readable storage media of claim 17, wherein the input scene data is an image or a video of the environment, and wherein the particular observer location is a location of the camera that captured the image or video in the environment.

19. The computer-readable storage media of claim 17, the operations further comprising:
providing the olfactory prediction to a hardware device that is configured to generate the predicted smell.

20. The computer-readable storage media of claim 17, wherein the olfactory prediction is a prediction of a scent at the particular observer location along a plurality of olfactory dimensions.
